(19) United States
(12) Patent Application Publication
(10) Pub. No.: US 2016/0352842 A1
(43) Pub. Date: Dec. 1, 2016

(54) PROXY ADVERTISEMENTS IN A NEIGHBOR AWARE NETWORK

(71) Applicant: QUALCOMM Incorporated, San Diego, CA (US)

(72) Inventors: Abhishek Pramod Patil, San Diego, CA (US); Santosh Paul Abraham, San Diego, CA (US); George Cherian, San Diego, CA (US); Alireza Raissinia, Monte Sereno, CA (US)

(21) Appl. No.: 15/165,949

(22) Filed: May 26, 2016

Related U.S. Application Data
(60) Provisional application No. 62/167,156, filed on May 27, 2015.
(60) Provisional application No. 62/205,617, filed on Aug. 14, 2015.

(51) Int. Cl. H04L 29/08; H04L 29/12

(52) U.S. Cl. CPC H04L 67/16; H04L 67/28; H04L 61/6022

(57) ABSTRACT

A method for sending one or more service discovery messages includes detecting, at a proxy device of a network, a client device having access to the network. The method also includes sending a service discovery message from the proxy device to one or more other devices in the network. The service discovery message is associated with a service and is sent on behalf of the client device. The client device is a publisher of the service of a subscriber of the service.

### I. CROSS-REFERENCE TO RELATED APPLICATIONS

The present application claims priority from U.S. Provisional Patent Application No. 62/167,156, filed May 27, 2015 and entitled “PROXY ADVERTISEMENTS IN A NEIGHBOR AWARE NETWORK” and U.S. Provisional Patent Application No. 62/205,617, filed Aug. 14, 2015 and entitled “PROXY ADVERTISEMENTS IN A NEIGHBOR AWARE NETWORK”, the contents of which are expressly incorporated herein by reference in their entirety.

### II. FIELD

The present disclosure is generally related to a neighbor aware network (NAN). More specifically, the present disclosure is related to advertising services in a NAN.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

A wireless device in a Neighbor Aware Network (NAN) may advertise a service to one or more other wireless devices in the NAN. As a non-limiting example, the wireless device may advertise a streaming audio service to the other wireless devices, and the other wireless devices may receive the advertisement and subscribe to the service. However, advertising the service may result in substantial power drain or battery drain at the wireless device. For example, services are typically advertised during discovery windows of the NAN. In order for the wireless device to advertise the service in each discovery window, the wireless device may be required to transition from a low power state, such as a sleep mode, to a high power state, such as an awake mode, at the beginning of each discovery window. Such repeated transitioning from the low power state to the high power state to advertise the service may result in substantial power drain.

### IV. SUMMARY

The present disclosure is directed to “proxy advertising” a service in a network. As a non-limiting example, the present disclosure may be direct to proxy advertising a service in a Neighbor Aware Network (NAN). However, it should be understood that that a NAN is merely one non-limiting example of a network that supports the techniques described herein. The techniques described in the present disclosure should not be limited to a NAN and may include any data-link network. As used herein, a service may be “proxy advertised” when the service is advertised by a proxy device, rather than by the provider device that provides the service. A provider device in the NAN may offer a service that other devices in the NAN may subscribe to. The provider device may register the service with a proxy device in the NAN, and the proxy device may proxy advertise the service to the other devices. For example, the proxy device may broadcast attributes of the service to the other devices.

To illustrate, the proxy device may transmit discovery proxy capability information to the provider device. For example, the proxy device may broadcast, multicast, or unicast the discovery proxy capability information to the provider device. The discovery proxy capability information may indicate features and/or attributes of the proxy device that are associated with proxy advertising services. Based on the discovery proxy capability information, the provider device may determine whether to register the service with the proxy device so that the proxy device will advertise the service to the other devices. If the provider devices determines to register the service with the proxy device, the proxy device and the provider device may undergo a registration operation during which the provider devices provides the proxy device with registration data. The registration data may include attributes that the proxy device is to advertise to the other devices, such as attributes about the service and attributes about the provider device. After the registration operation is complete, the proxy device may proxy advertise the service to the other devices during discovery windows of the NAN, such as by broadcasting select information in the registration data.

Because the proxy device advertises the services of the provider device during the discovery windows, the provider device may enter into or remain in a low power state, such as a sleep mode, during the discovery windows to conserve battery power. Thus, the present disclosure utilizes multi-hop service discovery within the NAN to conserve power at the provider device. For example, one hop may correspond to providing the registration data from the provider device to the proxy device, and another hop may correspond to proxy advertising the service at the proxy device to the other devices in the NAN. The multi-hop service discovery techniques may enable the provider device to have extended “sleep cycles” to conserve power. For example, instead of waking up at each discovery window, which may include waking up approximately every 500 milliseconds, the provider device may wake up approximately every 8 seconds for increased power savings while the proxy device is proxy advertising the service of the provider device on behalf of the provider device. Thus, the present disclosure may enable devices with longer sleep cycles to remain in the low power state while devices with shorter sleep cycles proxy advertise services of devices with longer sleep cycles.

According to one implementation of the disclosed techniques, a method for sending one or more service discovery messages includes detecting, at a proxy device of a network, a client device having access to the network and sending a service discovery message from the proxy device to one or more other devices in the network. The service discovery message is associated with a service and is sent on behalf of the client device. The client device is a publisher of the service or a subscriber of the service.

According to another implementation of the disclosed techniques, an apparatus for sending one or more service discovery messages includes a processor and a memory storing instructions executable to cause the processor to detect, at a proxy device of a network, a client device having access to the network. The apparatus also includes a transceiver operable to send a service discovery message from the proxy device to one or more other devices in the network. The service discovery message is associated with a service and is sent on behalf of the client device. The client device is a publisher of the service or a subscriber of the service.

According to another implementation of the disclosed techniques, a non-transitory computer-readable medium includes instructions for sending one or more service discovery messages. The instructions, when executed by a processor of a proxy device, cause the processor to perform operations including detecting a client device having access to a network associated with the proxy device and initiating transmission of a service discovery message from the proxy device to one or more other devices in the network. The service discovery message is associated with a service and sent on behalf of the client device. The client device is a publisher of the service or a subscriber of the service.

According to another implementation of the disclosed techniques, an apparatus for sending one or more service discovery messages includes means for detecting, at a proxy device of a network, a client device having access to the network. The apparatus also includes means for sending a service discovery message from the proxy device to one or more other devices in the network. The service discovery message is associated with a service and is sent on behalf of the client device.

According to another implementation of the disclosed techniques, a method for advertising discovery proxy capabilities includes generating, at a proxy device of a network, a frame including discovery proxy capability information and sending the frame to one or more other devices in the network. The discovery proxy capability information indicates proxy capabilities of the proxy device.

According to another implementation of the disclosed techniques, an apparatus for advertising discovery proxy capabilities includes a processor and a memory storing instructions executable by the processor to generate, at a proxy device of a network, a frame including discovery proxy capability information. The discovery proxy capability information indicates proxy capabilities of the proxy device. The apparatus also includes a transceiver operable to send the frame to one or more other devices in the network.

According to another implementation of the disclosed techniques, a non-transitory computer-readable medium includes instructions for advertising discovery proxy capabilities. The instructions, when executed by a processor of a proxy device, cause the processor to perform operations including generating a frame including discovery proxy capability information. The discovery proxy capability information indicates proxy capabilities of the proxy device. The operations also include initiating transmission of the frame to one or more other devices in a network associated with the proxy device.

According to another implementation of the disclosed techniques, an apparatus for advertising discovery proxy capabilities includes means for generating, at a proxy device of a network, a frame including discovery proxy capability information. The discovery proxy capability information indicates proxy capabilities of the proxy device. The apparatus also includes means for sending the frame to one or more other devices in the network.

According to another implementation of the disclosed techniques, a method for processing proxy capabilities of a proxy device include receiving, at a client device, a frame from the proxy device. The frame including discovery proxy capability information that indicates proxy capabilities of the proxy device. The method also includes determining whether to use the proxy device for proxy advertisement based on the discovery proxy capability information.

According to another implementation of the disclosed techniques, an apparatus for processing proxy capabilities of a proxy device include a transceiver of a client device that is operable to receive a frame from the proxy device. The frame includes discovery proxy capability information that indicates proxy capabilities of the proxy device. The apparatus also includes a processor and a memory storing instructions executable to cause the processor to determine whether to use the proxy device for proxy advertisement based on the discovery proxy capability information.

According to another implementation of the disclosed techniques, a non-transitory computer-readable medium includes instructions for processing discovery capabilities of a proxy device. The instructions, when executed by a processor of a client device, cause the processor to perform operations including processing a frame received from the proxy device. The frame includes discovery proxy capability information that indicates proxy capabilities of the proxy device. The operations also include determining whether to use the proxy device for proxy advertisement based on the discovery proxy capability information.

According to another implementation of the disclosed techniques, an apparatus for processing proxy capabilities of a proxy device include means for receiving, at a client device, a frame from the proxy device. The frame includes discovery proxy capability information that indicates proxy capabilities of the proxy device. The apparatus also includes means for determining whether to use the proxy device for proxy advertisement based on the discovery proxy capability information.

According to another implementation of the disclosed techniques, a method for registering a service for proxy advertisement includes selecting, at a client device, a proxy device to proxy advertise the service of the client device to one or more other devices in a network. The method also includes sending registration data from the client device to the proxy device.

According to another implementation of the disclosed techniques, an apparatus for registering a service for proxy advertisement includes a processor of a client device. The apparatus also includes a memory storing instructions executable to cause the processor to select a proxy device to proxy advertise the service of the client device to one or more other devices in a network. The apparatus also includes a transceiver operable to send registration data from the client device to the proxy device.

According to another implementation of the disclosed techniques, a non-transitory computer-readable medium includes instructions for registering a service for proxy advertisement. The instructions, when executed by a processor of a client device, cause the processor to perform operations including selecting a proxy device to proxy advertise the service of the client device to one or more other devices in a network. The operations also include initiating transmission of registration data to the proxy device.

According to another implementation of the disclosed techniques, an apparatus includes means for selecting, at a client device, a proxy device to proxy advertise the service of the client device to one or more other devices in a network. The apparatus also includes means for sending registration data from the client device to the proxy device.

One advantage provided by at least one of the disclosed implementations is an ability to conserve power at a provider device that offers a service to other devices in a Neighbor Aware Network (NAN). For example, the provider device may register the service with a proxy device in the NAN, and the proxy device may proxy advertise the service to the other devices. Thus, the provider device may enter into or remain in a low power state while the proxy device proxy advertises the service for the provider device (as opposed to the provider device transitioning into a high power state to advertise the service). Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram that illustrates a system that is operable to enable a provider device in a Neighbor Aware Network (NAN) to register a service with a proxy device for proxy advertisement;

FIG. 2 is a diagram that illustrates a system that is operable to enable the proxy device of FIG. 1 to proxy advertise the service of the provider device of FIG. 1;

FIG. 3 is a diagram that illustrates a system that is operable to enable the techniques of FIGS. 1-2;

FIG. 4A is a flow diagram of a method for advertising discovery proxy capabilities of a proxy device;

FIG. 4B is a flow diagram of a method for processing proxy capabilities of a proxy device;

FIG. 5A is a flow diagram of a method for registering a service for proxy advertisement;

FIG. 5B is a flow diagram of a method for sending one or more service discovery messages; and

FIG. 6 is a diagram of a wireless device that is operable to support various implementations of one or more methods, systems, apparatuses, and/or computer-readable media disclosed herein.

### VI. DETAILED DESCRIPTION

The disclosed systems, devices, and methods may enable a proxy device in a Neighbor Aware Network (NAN) to “proxy advertise” a service of a client device to other devices in the NAN. For example, the client device may register the service with the proxy device. Upon registration of the service, the proxy device may proxy advertise the service to one or more additional devices in the NAN. By enabling proxy advertising of the service by the proxy device, the client device may enter into or remain in a low power state, such as a “sleep mode”, for extended periods of time without sacrificing frequency of service advertising and while maintaining overall service availability in the NAN.

As used herein, a device may “advertise” services to other devices. It should be understood that “advertising” a service includes sending information associated with the service to other devices so that the other devices (that receive the information) may become aware of the service. A device may use a transceiver, a transmitter, or any other device (or circuitry) to advertise the service. Additionally, a device may “proxy advertise” services to other devices. It should be understood that “proxy advertisement” includes sending information about the service to other devices on behalf of another device. Thus, a device may use a transceiver, a transmitter, or any other device (or circuitry) to proxy advertise the service. “Advertising a service” in the context of the present disclosure may include sending information about the service to other devices using data links (e.g., NAN data links).

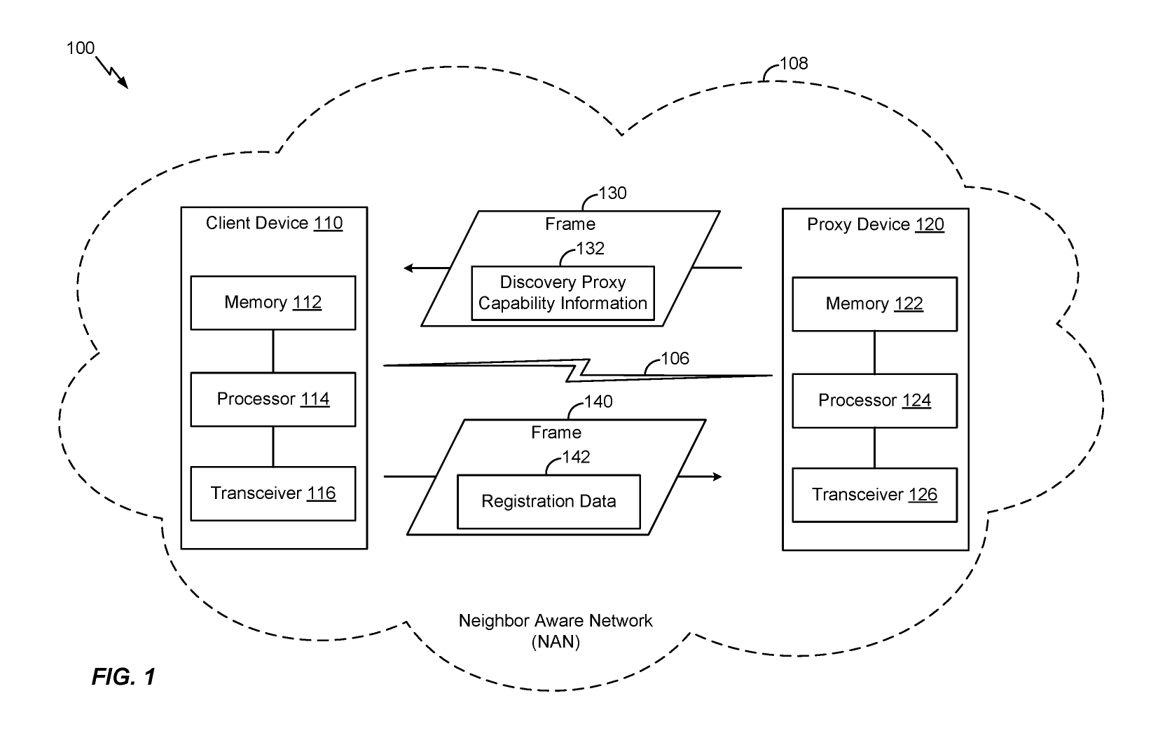

Referring to FIG. 1, a system 100 that is operable to enable a client device in a NAN 108 to register a service with a proxy device for proxy advertisement is shown. A client device 110 (e.g., a publisher device) and a proxy device 120 are included in the NAN 108. It should be noted that although FIG. 1 depicts two devices 110, 120, any number of devices may be present in the NAN 108. One or more of the devices 110, 120 may operate in compliance with one or more Institute of Electrical and Electronics Engineers (IEEE) 802.11 protocols. As non-limiting examples, the devices 110, 120 may operate in compliance with an IEEE 802.11ai protocol, an IEEE 802.11v protocol, an IEEE 802.11b protocol, etc. It should be understood that a device, such as the client device 110 and/or the proxy device 120, may perform multiple functions concurrently. For example, a device may be a proxy device, a client to another proxy device, a publisher device, a subscriber device, or a combination thereof, concurrently.

In some implementations, one or more of the devices 110, 120 may be a node of a wireless network. For example, one or more of the devices 110, 120 may be an IEEE 802.11 access point that supports and/or manages a corresponding wireless data network. The client device 110 may support a first network, and the proxy device 120 may support a second network. As an illustrative non-limiting example, a shopping mall scenario, the first network may correspond to a wireless network of a coffee shop and the second network may correspond to a wireless network of a clothing store.

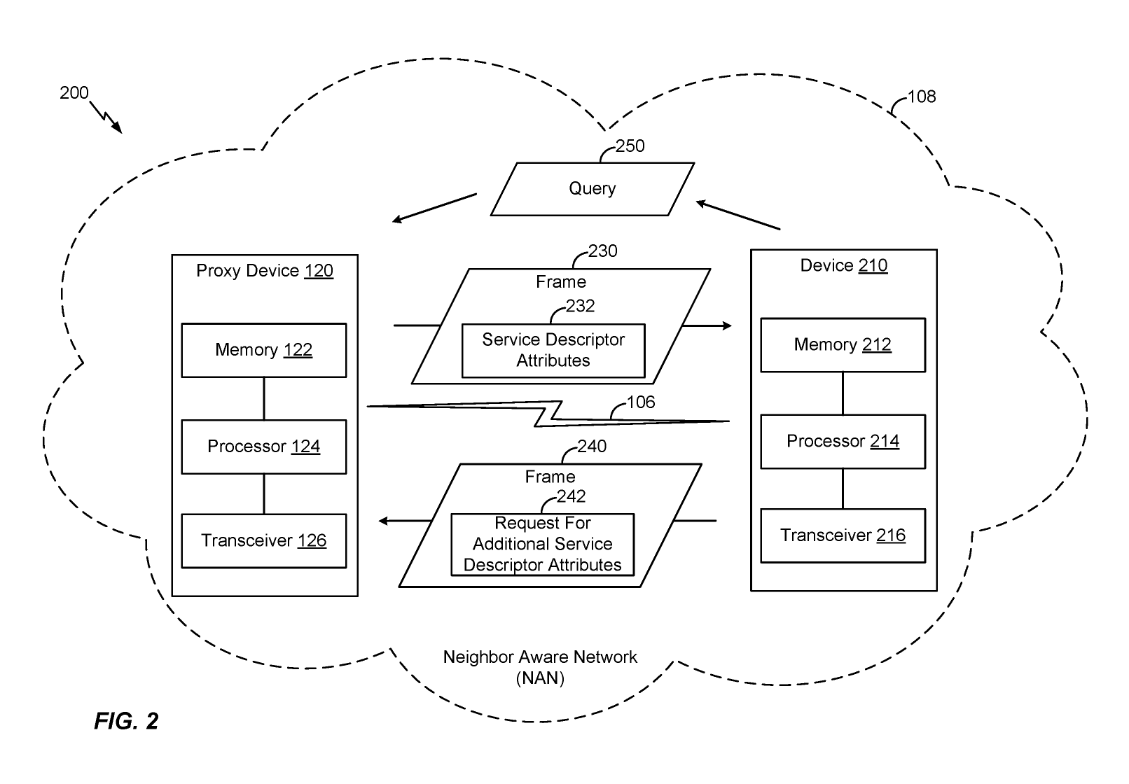

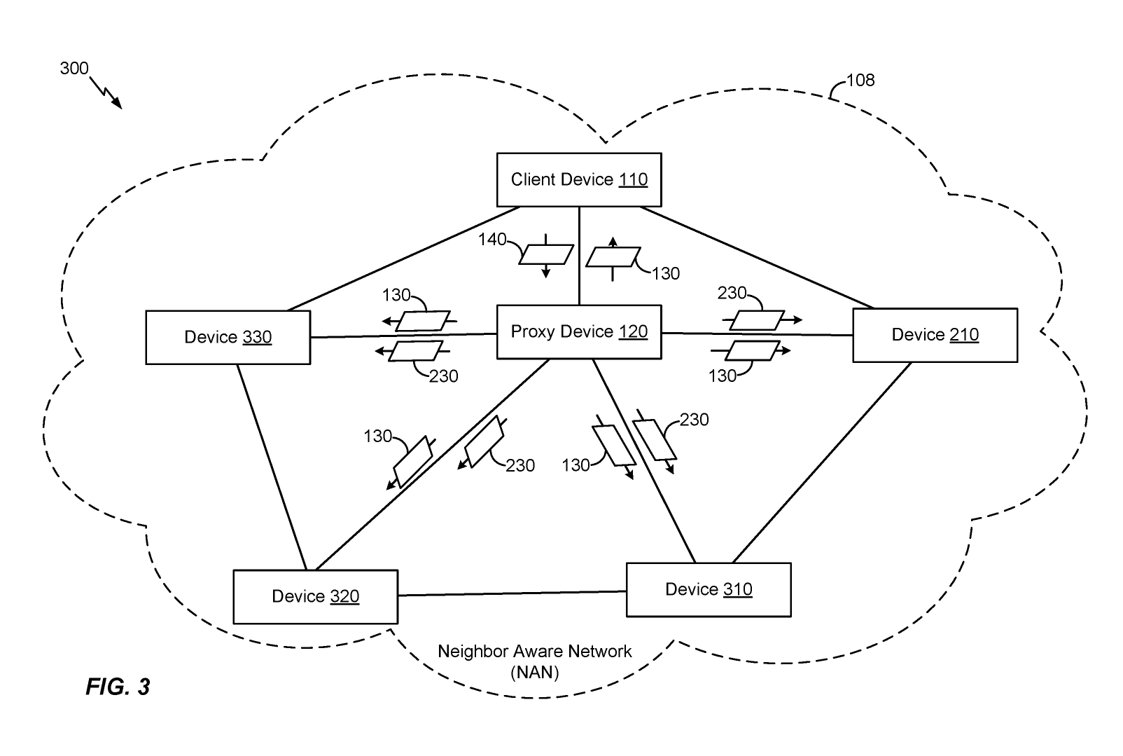

The client device 110 includes a memory 112, a processor 114, and a transceiver 116. The client device 110 may be configured to provide a service to one or more other devices in the NAN 108, which may include the proxy device 120 and/or devices not shown in FIG. 1, such as a device 210 of FIG. 2 and/or devices 310, 320, 330 of FIG. 3. As a non-limiting example, the client device 110 may provide a streaming audio service to the other devices in the NAN 108. It should be understood that the present disclosure is not limited to streaming audio services and may include techniques to proxy advertise other services. As other non-limiting examples, the client device 110 may also provide internet services, gaming services, streaming video services, etc.

In order for the other devices to subscribe to the service, the client device 110 may advertise the service to the other devices. However, advertising the service at the client device 110 may require the client device 110 to remain in an active state, such as an awake mode, for relatively long durations of time. For example, the client device 110 may enter into the awake mode during each discovery window of the NAN 108 to advertise the service to the other devices. Thus, advertising the service at the client device 110 may result in substantial battery drain at the client device 110. To alleviate battery drain at the client device 110, the proxy device 120 may proxy advertise the service of the client device 110 to the other devices in the NAN 108, as further described herein.

The proxy device 120 includes a memory 122, a processor 124, and a transceiver 126. The processor 124 may be configured to generate a frame 130 that includes discovery proxy capability information 132. The discovery proxy capability information 132 may indicate proxy capabilities of the proxy device 120. According to one implementation, the frame 130 includes a beacon frame. According to another implementation, the frame 130 includes a service discovery frame (SDF). The transceiver 126 may be configured to transmit the frame 130 to one or more other devices in the NAN 108. For example, the transceiver 126 may be configured to broadcast, multicast, or unicast the frame 130 to one or more other devices in the NAN 108. The transceiver 126 may transmit the frame during a discovery window of a network (e.g., the NAN 108), an advertised availability time outside of the discovery window of the network, a “well-known time” outside of the discovery window of the network, or a negotiated availability time outside of the discovery window of the network.

By transmitting the frame 130 to the client device 110, the transceiver 126 may also transmit the discovery proxy capability information 132 to the client device 110. According to the illustration of FIG. 1, the frame 130 is provided to the client device 110 via a NAN data link (NDL) 106 of the proxy device 120. For example, the client device 110 may “associate” with the proxy device 120 via the NAN data link 106 to receive the frame 130. The NAN data link 106 may include or correspond to a wireless mesh network, such as a “social wireless fidelity (Wi-Fi) mesh (SWF-mesh)”. The one or more devices of the NAN data link 106 may be a subset of devices in the NAN 108. As referred to herein, “data link (DL)”, “data path link”, “data path (DP)”, “NAN DP (NDP)”, or “NAN DP group” may refer to the NAN data link 106. Data exchanged via the NAN data link 106 may be protected based on security credentials. However, it should be understood that providing the frame 130 via the NAN data link 106 is for illustrative purposes only. In other implementations, the frame 130 may be broadcast to the client device 110 via an IEEE 802.11 protocol or may be provided to the client device 110 by other transmission techniques.

The proxy device 120 may use the discovery proxy capability information to advertise, to the client device 110, the capability of the proxy device 120 to perform a proxy function. Based on the discovery proxy capability information 132, the client device 110 may determine whether to use the proxy device 120 to proxy advertise the service. For example, the client device 110 may use the discovery proxy capability information 132 to determine whether to register the service with the proxy device 120.

According to one implementation, the discovery proxy capability information 132 may include a service identifier that indicates an availability of a proxy service. For example, the service identifier may be a unique identifier that indicates the proxy capabilities of the proxy device 120. The service identifier may be an offset value that indicates that the proxy device 120 is capable of proxy advertising a particular service that is defined by the offset value. Upon receiving the service identifier, the client device 110 may determine whether the offset number corresponds to the service provided by the client device 110. The client device 110 may register the service with the proxy device 120 for proxy advertisement if the offset number corresponds to the service of the client device 110. Otherwise, the client device 110 may select a different proxy device (not shown) to proxy advertise the service, or may advertise the service itself.

According to another implementation, the discovery proxy capability information 132 may indicate one or more proxy capability attributes or parameters of the proxy device 120. Thus, the proxy capability attributes may not only indicate that the proxy device 120 is available to proxy the service of the client device 110, but may also indicate parameters of the proxy device 120 to be “considered” by the client device 110 in determining whether to register the service with the proxy device 120 for proxy advertisement. Based on the proxy capability attributes, the client device 110 may determine whether to register the service with the proxy device 120.

One proxy capability attribute that may be included in the discovery proxy capability information 132 may indicate services of other devices (not shown) in the NAN 108 that are being proxy advertised by the proxy device 120 when the frame 130 is generated. For example, if the proxy device 120 is proxy advertising services for other devices, the client device 110 may determine whether to register the service with the proxy device 120 based on the services indicated in the discovery proxy capability information 132. According to one illustration, if the proxy capability attribute indicates that the proxy device 120 is currently proxy advertising multiple services, the client device 110 may determine that the proxy device 120 is “over-loaded” and may bypass registering the service with the proxy device 120. If the proxy capability attribute indicates that the proxy device 120 is not currently proxy advertising any services (or is proxy advertising a relatively small number of services), the client device 110 may register the service with the proxy device 120 for proxy advertisement. According to another illustration, if the proxy capability attribute indicates that the proxy device 120 is currently proxy advertising multiple services, the client device 110 may determine that the proxy device 120 is a “trustworthy” source and may register the service with the proxy device 120 for proxy advertisement.

Another proxy capability attribute that may be included in the discovery proxy capability information 132 may indicate a wake-up frequency or wake-up cycle of the proxy device 120. The wake-up frequency may indicate how frequently the proxy device 120 transitions into an active state to proxy advertise services. For example, the proxy device 120 may indicate whether it transitions into the active state at each discovery window of the NAN 108, at every other discovery window of the NAN 108, etc. The client device 110 may select a proxy device to proxy advertise the service based on the indication. To illustrate, if the proxy capability attribute indicates that the proxy device 120 is capable of proxy advertising the service at every other discovery window of the NAN 108 and if the client device 110 determines that advertising the service at every other discovery window of the NAN 108 is satisfactory, the client device 110 may select the proxy device 120 to proxy advertise the service. However, if data stored at the client device 110 indicates that the service should be proxy advertised more frequently, the client device 110 may select another proxy device to proxy advertise the service. For example, the client device may select a proxy device that transitions into the active state at each discovery window of the NAN 108 to proxy advertise the service.

Another proxy capability attribute that may be included in the discovery proxy capability information 132 is a power attribute of the proxy device 120. For example, the power attribute may indicate whether the proxy device 120 is connected to or “plugged” into a power source or whether the proxy device 120 is powered by a battery. The client device 110 may select a proxy device to proxy advertise the service based on the power attribute. For example, if the power attribute indicates that the proxy device 120 is connected to a power source, the client device 110 may determine that there is a relatively high likelihood that the proxy device 120 will be available or “powered on” at later times to proxy advertise the service. Alternatively, if the power attribute indicates that the proxy device 120 is powered by battery, the client device 110 may determine that there is a lower likelihood that the proxy device will be available at later times to proxy advertise the service. Thus, if data stored at the client device 110 indicates that longevity or a stable power source is a priority, the client device 110 may select the proxy device 120 to proxy advertise the service if the power attribute indicates that the proxy device 120 is connected to a power source.

Another proxy capability attribute that may be included in the discovery proxy capability information 132 may indicate how many services the proxy device 120 is able to proxy advertise. For example, the proxy device 120 may have the capacity to proxy advertise a limited number of services based on packet size constraints defined by NAN protocols and/or IEEE 802.11 protocols. The client device 110 may determine whether to register the service with the proxy device 120 based on how many services the proxy device 120 is able to proxy advertise. As a non-limiting example, the client device 110 may have N services to register for proxy advertisement, where N is an integer greater than one. If the proxy device 120 indicates a remaining capacity to proxy advertise less than N services, the client device 110 may select another proxy device to proxy advertise the services. If the proxy device 120 indicates a remaining capacity to proxy advertise N or more services, the client device 110 may select the proxy device 120 to proxy advertise each of the N services.

Another proxy capability attribute that may be included in the discovery proxy capability information 132 may indicate an amount of service information to be proxy advertised for each service of the client device 110. For example, the proxy device 120 may indicate that a particular number of “octets” of information for each service will be proxy advertised. If the proxy capability attribute indicates that less than a threshold number of octets of service information will be proxy advertised for each service, the client device 110 may register the service with a different proxy device. If the proxy capability attribute indicates that the number of octets of service information that will be proxy advertised for each service satisfies the threshold, the client device 110 may register the service with the proxy device 120 for proxy advertisement.

Another proxy capability attribute that may be included in the discovery proxy capability information 132 may indicate how much service information about services will be proxy advertised. To illustrate, the client device 110 may provide information about the service in a “service information field” of a packet provided to the proxy device 120. Due to packet size constraints, the proxy device 120 may be able to proxy advertise only a portion of the information in the service information field. The proxy capability attribute may indicate what portion of the information will be proxy advertised. For example, the proxy capability attribute may indicate that only the service identifier of the service will be proxy advertised, a “short version” of the service information field will be proxy advertised for each service, etc. The short version of the service information field may be referred to as a short service information field. The client device 110 may determine whether to register the service with the proxy device 120 based on what portion of the information is to be proxy advertised. For example, if only the service identifier of the service will be proxy advertised by the proxy device 120, the client device 110 may register the service with another proxy device. However, if at least a short service information field will be proxy advertised by the proxy device 120, the client device 110 may register the service with the proxy device 120 for proxy advertisement.

Another proxy capability attribute that may be included in the discovery proxy capability information 132 may indicate a frame-type used by the proxy device 120 to proxy advertise services. For example, if the proxy device 120 is a “master device”, the proxy device 120 may broadcast beacon frames to proxy advertise services. When beacon frames are broadcast to proxy advertise services, there may be relatively high probability that the service advertisements will be received by a relatively large number of devices. The client device 110 may determine whether to register the service with the proxy device 120 based on the frame-type indicated by the proxy device 120 in the discovery proxy capability information 132. For example, if reaching a relatively large number of devices is a high priority (in an ordered set of priorities) to the client device 110, the client device 110 may register the service with the proxy device 120 if the proxy device 120 proxy advertises services using beacon frames. The client device 110 may store data indicating what factors have a relatively high priority for each service provided by the client device 110. For example, the data for each service may indicate relative importance of reaching a large number of other devices, a minimum amount of service information that is to be advertised, a minimum number of octets of information for each service that is to be advertised, etc.

Another proxy capability attribute that may be included in the discovery proxy capability information 132 may indicate a duration that the proxy device 120 is available to proxy advertise the service of the client device 110. To illustrate, the client device 110 may determine to use a different proxy device (not shown) to proxy advertise the service if the proxy device 120 is unavailable to proxy advertise the service for at least a threshold time period. Another proxy capability attribute that may be included in the discovery proxy capability information 132 may indicate whether the proxy device 120 is accepting new registrations from client devices. As used herein, a “client device” may include a publisher device or a subscriber device. As used herein, exchanges between a proxy device and a publisher device may also be applicable between a proxy device and a subscriber device. A client device may provide a service and also subscribe to a service. Another proxy capability attribute that may be included in the discovery proxy capability information 132 may indicated whether the proxy device 120 supports unsolicited service discovery, whether the proxy device 120 supports solicited service discovery, or both.

The proxy capability attributes may be provided in a format in accordance with the format of Table 1. For example, the proxy capability attributes may have a one-octet sub-attribute identifier (ID) field, a one-octet length field, and a variable-length sub-attribute specific data field.

TABLE 1
Proxy Capability Attribute Format

| | Size | | |
|---|---|---|---|
| Field | (Octets) | Value (Hex) | Description |
| Sub- | 1 | Variable | Identifies the type of NAN Service |
| attribute | | | Discovery Proxy Sub-attribute |
| ID | | | |
| Length | 1 | Variable | Length of the following value |
| Value | Variable | Variable | Value specific to the type of the |
| | | | field |

According to one implementation, the one-octet sub-attributed ID field may use the identifiers in Table 2 to identify the sub-attribute.

TABLE 2
Sub-Attribute Identifiers

| Sub-attribute | |
|---|---|
| ID | Description |
| 0 | Proxy Registration |
| | Request |
| 1 | Proxy Registration |
| | Response |
| 2 | Proxy Registration |
| | Update |
| 3 | Proxy Deregistration |
| | Request |
| 4 | Proxy Deregistration |
| | Response |
| 5 | Discovery Report |
| | Request |
| 6 | Discovery Report |
| | Response |
| 7-255 | Reserved |

The client device 110 may be configured to select a proxy device to proxy advertise the service to other devices in the NAN 108. For example, based on one or more of the above-identified proxy capability attributes in the discover proxy capability information 132 and/or the service identifier in the discovery proxy capability information 132, the client device 110 may either select the proxy device 120 to proxy advertise the service, may select another proxy device (not shown) to proxy advertise the service, or may advertise the service itself. In some implementations, the client device 110 may select multiple proxy devices to proxy advertise the service to devices spanning a relatively large area.

If the client device 110 selects the proxy device 120 to proxy advertise the service to other devices in the NAN 108, the client device 110 may send registration data 142 to the proxy device 120 to initiate a registration operation that registers the service with the proxy device 120. For example, the discovery proxy capability information 132 may also include information indicating a window or a time period where the registration operation may occur. According to some implementations, the registration operation may occur outside of a discovery window of the NAN 108 due to the brevity of discovery windows. The processor 114 may generate a frame 140 that includes the registration data 142, and the transceiver 116 may send the frame 140 to the proxy device 120 during the designated window to initiate the registration operation. Thus, during the registration operation, the proxy device 120 may receive service information from the client device 110. Upon receiving the registration data 142, the proxy device 120 may perform the registration operation with the client device 110 to register the service. Registering the service may enable the proxy device 120 to proxy advertise the service to other devices in the NAN 108. The registration operation is described in greater detail below.

The registration data 142, which may include service information about the service, may define parameters of the service and/or parameters of the client device 110. The proxy device 120 may use the registration data 142 to register the service. According to one implementation, some of the registration data 142 may be included in a service information field, as described above. The registration data 142 may include a media access control (MAC) address of the client device 110. The registration data 142 may also include a service identifier of the service. For example, the registration data 142 may include a profile of the service, matching filter information of the service, or a combination thereof. The matching filter information may be based on a NAN protocol, an IEEE 802.11 protocol, or a combination thereof. The matching filter information may enable a receiving device to eliminate service advertisements or services that are “incompatible” with receiving device.

The registration data 142 may also include a discovery window schedule, such as a discovery window index wakeup schedule, of the client device 110. The discovery window schedule may indicate time periods, such as discovery windows, or other time periods such as “further availability windows”, where the client device 110 is in an active state. Thus, the discovery window schedule may enable the proxy device 120 (or other devices that receive the proxy advertisement from the proxy device 120) to communicate with the client device 110 for further service discovery. For example, devices may query the client device 110 for more information about the service during time periods indicated in the discovery window schedule. The registration data 142 may also include NAN data link information of the client device 110. The NAN data link information may indicate a NAN data link channel of the client device 110 and may also indicate a wakeup cycle of the client device 110.

The registration data 142 may indicate a time period for the proxy device 120 to proxy advertise the service. The time period may correspond to a “requested time limit of registration”. For example, the registration data 142 may indicate a requested time limit for the proxy device 120 to proxy advertise the service, alternatively referred to as “proxy advertisement timeline information”. To illustrate, the client device 110 may indicate to the proxy device 120 to proxy advertise the service a particular number of discovery windows, such as one-hundred discovery windows, or for a particular time period, such as fifteen minutes. The registration data 142 may also include ranging information or requirements of the client device 110. The ranging information or requirements may indicate a location, such as a global positioning system (GPS) location, of the client device 110, one or more time periods that the client device 110 is operable for ranging operations according to NAN protocols, a distance between the proxy device 120 and the client device 110, etc.

The registration data 142 may also include post discovery capability information of the client device 110. The post discovery capability information may include information about an infrastructure that the client device 110 is connected to. As a non-limiting example, the post discovery capability information may include basic service set (BSS) identification information associated with the client device 110, information indicating communication protocols associated with the client device 110, etc.

The client device 110 may register the service with the proxy device 120 using the NAN data link 106 of the proxy device 120. For example, the client device 110 may receive an advertisement from the proxy device 120 indicating properties of the NAN data link 106. According to one implementation, the advertisement may be included in the discovery proxy capability information 132 sent to the client device 110. The client device 110 may associate with the proxy device 120 via the NAN data link 106 based on the properties, and may send the registration data 142 to the proxy device 120 using the NAN data link 106 to initiate the registration operation. Alternatively, the registration operation may be performed using existing NAN data link communications between the devices 110, 120. The existing NAN data link communications may include leveraged NAN data link signaling and NAN data link time blocks. The registration operation may include a two-way handshake (or a four-way handshake) between the devices 110, 120. During the registration operation, the proxy device 120 may also indicate how long the proxy device 120 will proxy advertise the service, alternatively referred to as a “maximum validity time of registration”. After sending the registration data 142 (or after completing the registration operation), the client device 110 may discontinue operations on the NAN data link 106.

Proxy advertising of the service may be terminated by the proxy device 120 prior to expiration of the maximum validity time of registration. Termination may be initiated by the proxy device 120 or by the client device 110. As a non-limiting example, the proxy device 120 may initiate termination of the proxy advertising if a remaining battery power at the proxy device 120 is less than a threshold. As another example, the client device 110 may initiate termination of the proxy advertising if the client device 110 is no longer offering the service or if the client device 110 is leaving the NAN 108.

Additionally, if the client device 110 or the proxy device 120 leaves the NAN 108 or changes NAN clusters, the exiting device may notify the other device to terminate the proxy operation. In some implementations, the client device 110 and the proxy device 120 may remain in the NAN 108 as long as proxy advertising of the service is ongoing.

According to some implementations, the proxy device 120 may periodically send queries (or data frames) to the client device 110 to solicit updates related to the services of the client device 110 that are being proxy advertised. According to an exemplary implementation, each query may be sent outside a discovery window of the NAN 108. For example, each query may be sent according to a NAN data link schedule of the proxy device 120, according to an IEEE 802.11 standard, according to a NAN specification standard, or according to a negotiated time between the proxy device 120 and the client device 110. The queries may also serve as a “heartbeat” to determine whether the proxy device 120 and/or the client device 110 is available. For example, if the proxy device 120 sends a query to the client device 110 and does not receive a response within a particular time period, the proxy device 120 may determine that the client device 110 is no longer available or is no longer interested in the proxy device 120 proxy advertising its services. Thus, the proxy device 120 may discontinue proxy advertisement of the service if the proxy device 120 fails to receive a response to a query within the particular time period. The proxy device 120 may continue proxy advertisement of the service if the proxy device 120 receives a response to the query within the particular time period. The query may indicate to the client device 110 that the proxy device 120 is proxy advertising the service. For example, if the client device 110 does not receive a query from the proxy device 110 within a particular time period, the client device 110 may determine that the proxy device 120 is no longer available or is no longer interested in proxy advertising services of the client device 110. In certain implementations, non-periodic queries may be sent to inform devices that proxy services are no longer available.

In some scenarios, a query from the proxy device 120 (e.g., a server) may include updates to the negotiated parameters. A client device (e.g., a publisher device or a subscriber device) may acknowledge the query and begin using the new parameters or may discontinue using the proxy device 120 if the updated parameters are unacceptable.

According to some implementations, a proxy device 120 may be a “primary” proxy device and may designate another device as a “secondary” proxy device (not shown). The secondary proxy device may monitor activity of the proxy device 120 and may take over the proxy advertising duties of the proxy device 120 if the proxy device 120 fails to successfully proxy advertise services or becomes unavailable. By implementing a secondary proxy device in the system 100, the client device 110 may have a longer sleep duration because two (or more) devices may be equipped and ready to proxy advertise the services of the client device 110.

According to some implementations, a client device (e.g., the client device 110) may deregister a service from the proxy device 120. If the client device deregisters the service from the proxy device 120, the proxy device 120 may stop proxy advertising the service to other devices on behalf of the client device. If the proxy device 120 becomes unavailable, the client device may register with another proxy device to proxy advertise the service or the client device may self-advertise the service to other devices. According to one implementation, the client device may use active subscription to find the proxy device 110. If the client device discovers multiple proxy devices, the client device may select a proxy device based on certain criteria. The criteria may include which proxy device responded to a query of the client device the fastest, the signal strength of a received frame for the proxy devices, whether a particular proxy device is associated with a common NDL, other services that are advertised by the proxy devices, advertising constraints indicated by the proxy devices, etc.

According to one implementation, if a particular device participates in a NDL for a particular service that is to be available over multi-hop, the particular device may function as a proxy for one or more publishers in the NDL. Additionally, the proxy device 120 may forward packets belonging to services in the NDL if the particular device is an intermediate node of a multi-hop route. A publisher of a service may indicate support for multi-hop via one or more parameters in a service discovery message. In other scenarios, multi-hop may be a property of a service. According to one implementation, a publisher of a service may publish the service in response to detecting a subscription message (e.g., a solicited publishing operation). According to another implementation, a publisher of a service may publish the service without detecting a subscription message (e.g., an unsolicited publishing operation).

The system 100 of FIG. 1 may enable the client device 110 to register the service with the proxy device 120. Registering the service with the proxy device 120 may enable the proxy device 120 to proxy advertise the service to one or more other devices (not shown) in the NAN 108 while the client device 110 is in a low power state. Thus, by registering the service with the proxy device 120, the service may be advertised within the NAN 108 while the client device 110 conserves battery power by entering into the low power state.

Thus, the techniques described with respect to FIG. 1 include a proxy server (e.g., the proxy device 120) that is discoverable through NAN service discovery during NAN discovery windows. Subsequent message exchanges between the proxy server and a proxy client (e.g., the client device 110) after the initial discovery may occur outside of the NAN discovery windows. According to some implementations, at least one period outside of the NAN discovery windows may be designated for transmissions of “NAN2” service discovery proxy protocol messages. The proxy server and the proxy client may exchange NAN2 service discovery protocol messages for registration operations, for deregistration operations, for subscription operations, and for discovery reports.

According to the techniques described herein, a NAN service discovery proxy includes three interfaces that may be used to interact with other elements in a NAN2 device. A first interface may control operations of the proxy functionality in the NAN2 device. The first interface may be used to activate and deactivate the proxy client and the proxy server in the NAN2 device and to control operations. A second interface may be between a NAN discovery engine and the proxy client. The NAN discovery engine use the second interface to request registration (or deregistration) of a publisher or subscriber. The proxy client may use the second interface to provide reports (related to a registered subscriber) to the NAN discovery engine. Additionally, the proxy client may use the second interface to notify the NAN discovery engine of changes in availability of a proxy server. A third interface may be used by the proxy server to publish a proxy server service. The proxy server may also user the third interface to transmit follow-up messages to proxy clients and to receive follow-up messages from proxy clients. The proxy client may use the third interface to discover a proxy server, to transmit follow-up messages to the proxy server, and to receive follow-up messages from the proxy server.

According to one implementation, the NAN discovery engine may request the proxy client to register a first “instance” of a publish function to a proxy server in another NAN device. The NAN discovery engine may also request that the proxy client deregister the first instance of the publish function in the proxy server. According to one implementation, the NAN discovery engine may request the proxy client to register a second instance of a subscribe function to a proxy server in another NAN device. The NAN discovery engine may also request that the proxy client deregister the second instance of the subscribe function in the proxy server.

A NAN2 device may operate as a proxy server and may run a solicited publish operation to make the proxy server discoverable. The proxy server may provide techniques for proxy clients to offload an instance in NAN2 devices to the proxy server. The proxy server may allow a proxy client to register an instance to the proxy server. Once the proxy server accepts a registration request from a proxy client, the proxy server publishes (or subscribes) on behalf of the proxy client.

Referring to FIG. 2, a system 200 that is operable to enable the proxy device 120 in the NAN 108 to proxy advertise the service of the client device 110 is shown. In FIG. 2, the proxy device 120 and the device 210 are included in the NAN 108. It should be noted that although FIG. 2 depicts two devices 120, 210, any number of devices may be present in the NAN 108. As a non-limiting example, the client device 110 of FIG. 1 may also be included in the NAN 108; however, for ease of illustration, only the devices 120, 210 are shown in FIG. 2. Thus it is to be understood that FIG. 1 and FIG. 2 may correspond to views of different subsets of devices present within the same NAN 108 at the same time.

After completion of the registration operation described with respect to FIG. 1, the proxy device 120 may proxy advertise the service of the client device 110 to the other devices in the NAN 108, such as the device 210. For example, the processor 124 may generate a frame 230 indicating one or more service descriptor attributes 232. The transceiver 126 may transmit the frame 230 to the device 210 during a discovery window of the NAN 108 to proxy advertise the service of the client device 110. In one implementation, the frame 230 may include a beacon frame that is broadcast to other devices (including the device 210) in the NAN 108.

The service descriptor attributes 232 may include one or more attributes associated with the registration data 142 of FIG. 1. For example, the service descriptor attributes 232 may include attributes of the client device 110, attributes of the service provided by the client device 110, attributes designed to assist the device 210 in subscribing to the service, or a combination thereof. To illustrate, the service descriptor attributes 232 may include the MAC address of the client device 110, information indicating time periods when the client device 110 is (or will be) in the active state, etc.

The service descriptor attributes 232 may also include information indicating a received signal strength of the client device 110 with respect to the proxy device 120. For example, a received signal strength indicator (RSSI) may indicate a proximity of the client device 110 with respect to the proxy device 120, and thus may be used to determine or estimate a proximity of the client device 110 with respect to the device 210 attempting to subscribe to the service. The service descriptor attributes 232 may also include a “freshness indicator” indicating an amount of time that has elapsed since the proxy device 120 received a signal from the client device 110. If the amount of time that has elapsed is relatively large, there exists a relatively large possibility that the client device 110 has left the NAN 108 and that the service is no longer available. Alternatively, if the amount of time that has elapsed is relatively small, there exists a relatively large possibility that the client device 110 is in the NAN 108 and that the service is available.

The service descriptor attributes 232 may also include information indicating a NAN data link schedule of the client device 110. The NAN data link schedule of the client device 110 may enable a subscribing device, such as the device 210, to communicate directly with the client device 110, using a NAN data link of the client device 110, to receive additional information about the service.

According to one implementation, the frame 230 may also include information associated with services from a plurality of other client devices (not shown) of the NAN 108 that are proxy advertised by the proxy device 120. For example, the frame may include service descriptor attributes of each service (and each corresponding client device) that is proxy advertised by the proxy device 120.

The device 210 includes a memory 212, a processor 214, and a transceiver 216. The transceiver 216 may receive the frame 230, and the device 210 may determine whether to subscribe to the service of the client device 110 (and/or subscribe to services of other devices) based on the service descriptor attributes 232 and/or other information in the frame 230.

According to some implementations, the proxy device 120 may also be configured to store additional information about the service of the client device 110. For example, due to packet size limitations, the proxy device 120 may not be able to provide the device 210 with all the “relevant” information about the service. Thus, the proxy device 120 may cache additional information about the service in the memory 122. The frame 230 may include information indicating whether the proxy device 120 is available to provide additional information regarding the service. For example, the frame 230 may indicate whether the proxy device 120 has additional service descriptor attributes cached at the memory 122. The frame 230 may also include information indicating time periods for the device 210 to query the proxy device 120 for the additional information. According to one implementation, the proxy device 120 may receive the additional information from the client device 110 in a “follow up” process after the client device 110 provides the registration data 142 to the proxy device 120 after “initial discovery”.

The device 210 may also transmit a frame 240 to the proxy device 120 upon receiving the frame 230. The frame 240 may include a request for additional service descriptor attributes 242. For example, if the frame 230 indicates that additional information regarding the service is cached at the memory 122 of the proxy device 120, the device 210 may send the request for additional service descriptor attributes 242 to the proxy device.

After receiving the request for additional service descriptor attributes 242 from the device 210, the proxy device 120 may transmit the additional service descriptor attributes to the device 210 via the NAN data link 106. The additional service descriptor attributes may include the additional information regarding the service cached at the memory 122. Although the NAN data link 106 of the proxy device 120 is shown to communicate data between the proxy device 120 and the client device 110 in FIG. 1 and to communicate data between proxy device 120 and the device 210 in FIG. 2, it should be understood that the proxy device 120 may be associated with multiple NAN data links. For example, a first NAN data link of the proxy device 120 may be used to communicate data between the proxy device 120 and the client device 110, and a second NAN data link of the proxy device 120 may be used to communicate data between the proxy device 120 and the device 210. Thus, usage of a single NAN data link 106 should not be construed as limiting. The device 210 may use the additional information regarding the service to determine whether to subscribe to the service.

According to some implementations, a subscriber device, such as the device 210, may transmit a frame to the proxy device 120 to indicate that the subscriber device has requested to subscribe to a particular service. As a non-limiting example, the subscriber device may transmit a frame to the proxy device 120 indicating that the subscriber device is requesting to subscribe to a streaming music service. After transmitting the frame to the proxy device 120, the subscriber device may enter a low-power mode to conserve battery power while the proxy device 120 attempts to identify a device providing the streaming music service. Thus, the subscriber device may register with the proxy device 120 and may request that the proxy device 120 act as a subscriber on its behalf. For example, the proxy device 120 may perform a registration operation to register a subscription request of the subscriber device with the proxy device 120. Registering the subscription request may enable the proxy device 120 to discover services associated with the subscription request on behalf of the subscriber device. As described below, the subscriber device may register with the proxy device 120 according to the proxy device's 120 NAN data link schedule or during a fixed time block outside of a NAN discovery window of the NAN 108.

The proxy device 120 may solicit data from other devices using an “active” technique by transmitting “subscription messages” or service discovery messages to the other devices, such as the client device 110 of FIG. 1, according to a NAN data link schedule. For example, the proxy device 120 may broadcast a frame to the client device 110 (and to other devices within a broadcast range of the proxy device 120). The frame may request other devices to transmit data regarding offered services or may request other devices to indicate whether a specific service, such as the streaming music service, is offered. Thus, the proxy device 120 may transmit subscription messages to other devices in the NAN 108 to discover services associated with the subscription request. If the client device 110 transmits data indicating that the client device 110 is offering a streaming music service, the proxy device 120 may proxy advertise service descriptor attributes of the client device 110 and the corresponding streaming music service to the subscriber device. Based on the service descriptor attributes, the subscriber device may subscribe to the streaming music service of the client device 110.

The proxy device 120 may also identify devices providing the streaming music service based on an unsolicited technique or a “passive” technique. For example, without sending a subscription message, the proxy device 120 may receive or “listen for” frames from different client devices indicating services offered by the client devices. Thus, the proxy device 120 may detect services associated with the subscription request without transmitting subscription messages to other devices in the NAN 108. In response to determining that one of the client devices offers a streaming music service, the proxy device 120 may proxy advertise service descriptor attributes of the client device and the corresponding streaming music service to the subscriber device. Based on the service descriptor attributes, the subscriber device may subscribe to the streaming music service of the client device. It should be understood that a streaming music service is a non-limiting example of one service that may be offered by a client device. Client devices may offer other services, such as streaming video services, gaming services, etc., in conjunction with the techniques described herein.

The system 200 of FIG. 2 may enable the proxy device 120 to proxy advertise the service of the client device 110 to one or more devices 210 of the NAN after the registration operation described with respect to FIG. 1 is complete. For example, the proxy device 120 may provide the service descriptor attributes 232 of the service to the device 210, and based on the service descriptor attributes 232, the device 210 may determine whether to subscribe to the service of the client device 110. In some implementations, the device 210 may rebroadcast the service descriptor attributes 232 of the service to another device (not shown), and the other device may determine whether to subscribe to the service of the client device 110. Thus, it should be understood that the techniques described herein are not merely limited to one-hop or two-hop NAN service discovery, but may also be implemented using three-hop (or more) NAN service discovery.

Although the techniques described with respect to FIGS. 1-2 indicate the exchange of proxy related information and/or “registration information” according to NAN data link scheduling, in other implementations, a fixed time block after a NAN discovery window may be designated for exchanging proxy related information and/or the registration information. The fixed time block may be defined in an applicable standard, such as an IEEE 802.11 standard and/or a NAN specification standard. During this fixed time block or “post-discovery” window, proxy related activities, such as the proxy related activities described with respect to FIGS. 1-2, may be performed. Other activities, such as ranging negotiation, NAN data link negotiation, etc., may also be performed during the post-discovery window. In certain implementations, the post-discovery window may be negotiated between devices in the NAN 108. Additionally, in some instances, the proxy related information and/or the registration information may be exchanged during NAN discovery windows of the NAN 108.

A client device, such as the client device 110 of FIG. 1, interested in having its service proxy advertised may provide service related details to the proxy device 120 during the fixed time block or by connecting to a NAN data link of the proxy device 120. The proxy device 120 may save the service related details and may provide the service related details to any subscriber device, such as the device 210, requesting a service offered by the client device.

In some implementations of the systems 100-200 of FIGS. 1-2, the proxy device 120 may advertise or offer its proxy advertisement capabilities as a service. For example, the proxy device 120 may advertise its proxy advertisement capabilities to the client device 110 and may indicate the NAN data link 106 where the client device 110 may connect. The client device 110 may connect to the NAN data link 106 and provide service related details, such as the registration data 142, to the proxy device 120. The proxy device 120 may save the registration data 142 and advertise the service to any device that queries the proxy device 120 for a similar service. For example, the device 210 may connect to the proxy device's 120 NAN data link 106 to send a query 250 to the proxy device 120 for a particular service. Upon receiving the query 250, the proxy device may proxy advertise the service of the client device 110 to the device 210 based on the saved registration data 142 at the proxy device 120.

In implementations where the proxy device 120 offers its proxy advertisement capabilities as a service, a service identifier may be used to indicate the proxy functionality of the proxy device 120. The service identifier may be defined in an applicable standard, such as an IEEE 802.11 standard and/or a NAN specification standard, and the service identifier may be transmitted by the proxy device 120 in a data frame. For example, the proxy device 120 may advertise its proxy advertisement capabilities to devices in the NAN 108 using the data frame having the service identifier. Upon receiving the data frame having the service identifier, other devices may register services with the proxy device 120 for proxy advertisement according to the techniques described with respect to FIGS. 1-2. In advertising its proxy service, the proxy device 120 may provide information or attributes about the proxy service using service descriptor attributes in a service information field. For example, the service information field may include additional capability information of the proxy device 120, such as the capabilities described in FIGS. 1-2.

According to some implementations, the proxy device 120 may be an access point (or any device that is connected to a power source or any device having a bridged connection to the Ethernet). The access point may advertise to other devices that it is proxy capable according to the techniques described with respect to FIGS. 1-2. Interested client devices may register with the access point to proxy advertise services of the client device and interested subscriber devices may register with the access point to find services on behalf of the subscriber devices. The access point may notify a subscriber device upon finding a “desired” service for the client device. The access point may also proxy advertise services on a backhaul network to devices in the NAN 108 and may forward queries/data from the devices in the NAN 108 to a service provider of the backhaul network. For example, if the access point has access to an infrastructure service, such an internet service, the access point may proxy advertise the infrastructure service to one or more devices in the NAN 108. If a device in the NAN 108 has queries about the infrastructure service, the access point may forward the query to the service provider of the infrastructure service.

According to some implementations, a proxy device may aggregate multiple proxy requests into a single service discovery frame (SDF). As a non-limiting example, if two client devices (e.g., publishers) and three subscribers have registered with a proxy device, the proxy device may transmit a single SDF that includes each service that the proxy device is proxy advertising if the proxy device supports aggregation. The single SDF may include multiple service descriptor attributes (SDA). For example, the single SDF may include one SDA for each frame. Alternatively, the proxy device may use a bloom filter to advertise multiple services. According to some implementations, the proxy device may aggregate based on the type of client device (e.g., publisher device or subscriber device), based on advertising techniques (e.g., solicited or unsolicited), based on some other criteria, or a combination thereof. In such scenarios, the proxy device may aggregate the proxy requests into multiple SDFs (e.g., one for each category). According to one implementation, if solicited and unsolicited services are aggregated together, the mode of proxy advertisement may be active (e.g., solicited).

Referring to FIG. 3, a system 300 that is operable to enable the techniques of FIGS. 1 and 2 is shown. The system 300 includes the client device 110, the proxy device 120, the device 210, and additional devices 310, 320, and 330.

The proxy device 120 may broadcast the frame 130 to each device 110, 210, 310, 320, 330 within a broadcast range of the proxy device 120. In response to receiving the frame 130 (and the included discovery proxy capability information 132), the client device 110 may establish a connection with (or “associate” with) the proxy device 120 via the NAN data link 106 and send the frame 140 to the proxy device 120 using the NAN data link 106 to initiate the registration operation. As described above, the client device 110 may send the frame 140 to the proxy device 120 during a window indicated by the proxy device 120 in the frame 130.

After the registration operation is complete, the proxy device 120 may proxy advertise the service of the client device 110 to the other devices 210, 310, 320, 330 in the NAN 108. For example, the proxy device 120 may broadcast the frame 230 to each device within the broadcast range of the proxy device 120.

In some implementations, the proxy device 120 may store the service identifier of the service and the client device's 110 NAN data link schedule. A device interested in the service, may send a query to the client device 110 during an active period according to the NAN data link schedule.

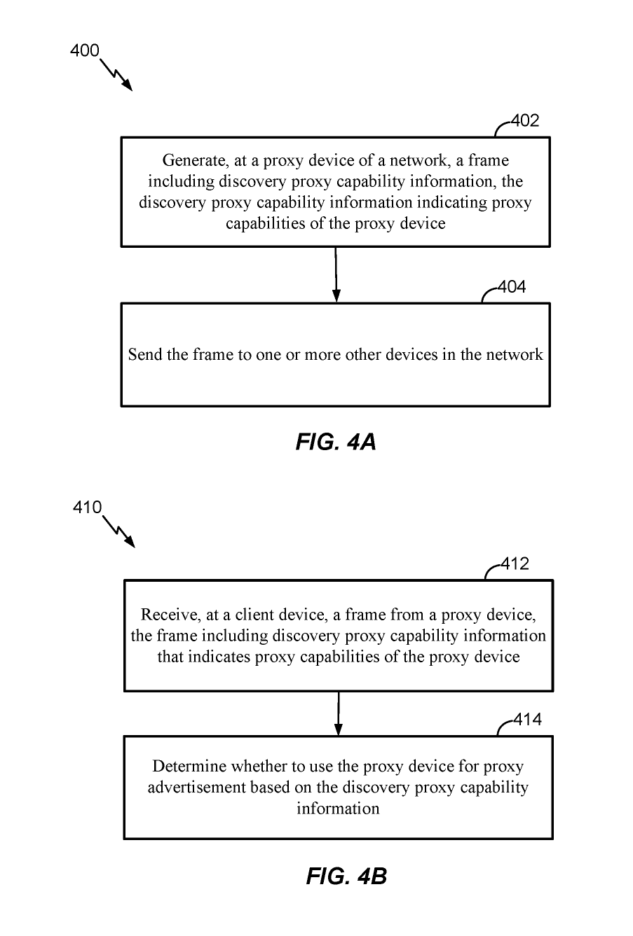

Referring to FIG. 4A, a method 400 for advertising discovery proxy capabilities of a proxy device is shown. The method 400 may be performed at the proxy device 120 of FIGS. 1-3.

The method 400 includes generating, at a proxy device of a network, a frame including discovery proxy capability information, at 402. The discovery proxy capability information may indicate proxy capabilities of the proxy device. For example, referring to FIG. 1, the processor 124 may generate the frame 130 that includes the discovery proxy capability information 132 indicating proxy capabilities of the proxy device 120. Based on the discovery proxy capability information 132, the client device 110 may determine whether to use the proxy device 120 to proxy advertise the service, such as by registering the service with the proxy device 120.

The method 400 also includes sending the frame to one or more other devices in the network, at 404. For example, referring to FIG. 1, the transceiver 126 may send the frame 130 to one or more other devices in the NAN 108. Thus, according to one implementation, the network includes a Neighbor Aware Network (NAN).

According to one implementation, the method 400 includes performing, at the proxy device, a registration operation to register a service of a client device with the proxy device. Registering the service may enable the proxy device to proxy advertise the service to a least one device of the one or more devices. The method 400 may also include generating, at the proxy device, a second frame indicating one or more service descriptor attributes of the client device. The method 400 may further include sending the second frame to the one or more other devices. According to one implementation, the second frame includes information associated with services from a plurality of client devices of the network that are proxy advertised by the proxy device. According to one implementation, the second frame includes information indicating whether the proxy device is available to provide additional information regarding the service.

According to one implementation, the method 400 comprises receiving, at the proxy device, a request for additional service descriptor attributes of the client device from a particular device after transmitting the second frame. The method 400 also includes sending the additional service descriptor attributes from the proxy device to the particular device in a third frame via a data link of the proxy device. According to one implementation, the one or more service descriptor attributes include a media access control (MAC) address of the client device. According to one implementation, the one or more service descriptor attributes include information indicating time periods when the client device is in an active state.

Referring to FIG. 4B, a method 410 for processing proxy capabilities of a proxy device is shown. The method 410 may be performed at the client device 110 of FIGS. 1 and 3, the device 210 of FIGS. 2-3, one or more of the devices 310, 320, 330 of FIG. 3, or a combination thereof.

The method 410 includes receiving, at a client device, a frame from the proxy device, at 412. The frame includes discovery proxy capability information that indicates proxy capabilities of the proxy device. For example, referring to FIG. 1, the client device 110 may receive the frame 130 from the proxy device 120. The frame 130 includes discovery proxy capability information 132 that indicates proxy capabilities of the proxy device 120.

The method 410 also includes determining whether to use the proxy device for proxy advertisement based on the discovery proxy capability information, at 414. For example, referring to FIG. 1, the client device 110 may determine whether to use the proxy device 120 for proxy advertisement based on the discovery proxy capability information 132. According to one implementation, the discovery proxy capability information 132 indicates one or more proxy capability attributes of the proxy device 120.

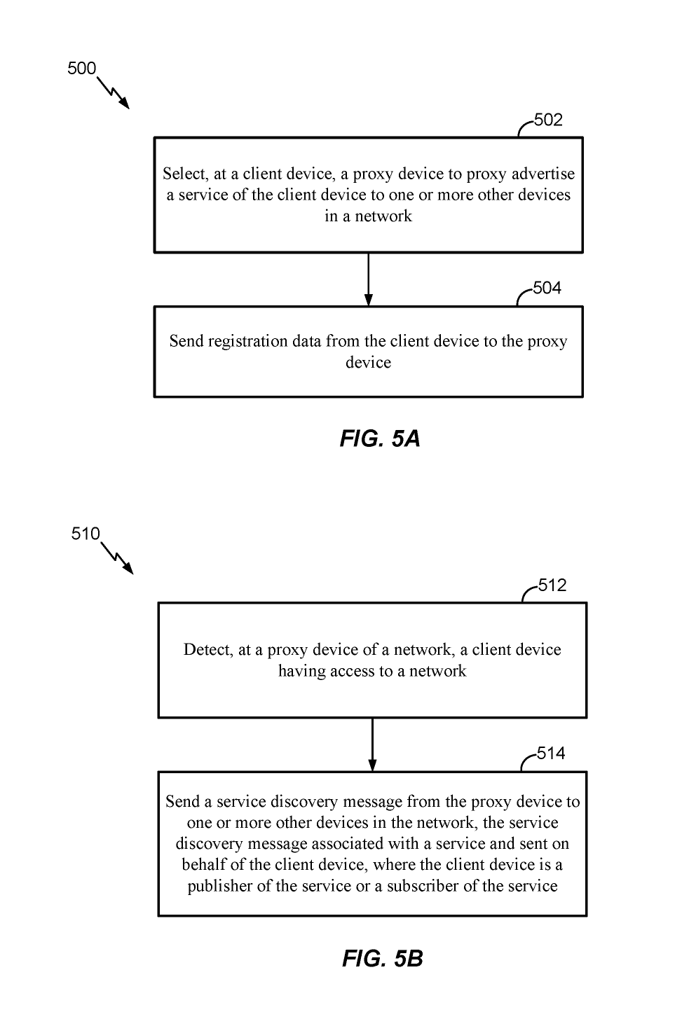

Referring to FIG. 5A, a method 500 for registering a service for proxy advertisement is shown. The method 500 may be performed at the client device 110 of FIGS. 1 and 3, the device 210 of FIGS. 2-3, one or more of the devices 310, 320, 330 of FIG. 3, or a combination thereof.

The method 500 includes selecting, at a client device, a proxy device to proxy advertise a service of the client device to one or more other devices in a network, at 502. For example, referring to FIG. 1, the client device 110 may select the proxy device 120 to proxy advertise the service of the client device to the other devices 210, 310, 320, 330 in the network (e.g., the NAN 108).

The method 500 also includes sending registration data from the client device to the proxy device, at 504. For example, referring to FIG. 1, the client device 110 may send registration data 142 to the proxy device 120 to initiate a registration operation that registers the service with the proxy device 120.

According to one implementation, the method 500 may include registering the service with the proxy device using a data link of the proxy device. Registering the service may include receiving, at the client device, an advertisement from the proxy device indicating properties of the data link of the proxy device. Registering the service may also include establishing a connection with the proxy device via the data link based on the properties. Registering the service may further include sending the registration data from the client device to the proxy device using the data link. According to one implementation, the method 500 may include discontinuing operations on the data link after sending the registration data to the proxy device. For example, after registration of the service is complete, the client device may discontinue use of the data link to communicate with the proxy device, and the proxy device may proxy advertise the service of the client device to the other devices.

Referring to FIG. 5B, a method 510 for sending one or more service discovery messages is shown. The method 510 may be performed at the proxy device 120 of FIGS. 1-3.

The method 510 includes detecting, at a proxy device of a network, a client device having access to the network, at 512. For example, referring to FIG. 1, the processor 124 of the proxy device 120 may be operable to detect the client device 110. According to one implementation, the processor 124 may detect the client device 110 based on a received signal sent from the client device 110.

The method 510 also includes sending a service discovery message from the proxy device to one or more other devices in the network, at 514. The service discovery message is associated with a service and is sent on behalf of the client device. The client device may be a publisher of the service or a subscriber of the service. According to one implementation, the network includes a Neighbor Aware Network (NAN). For example, referring to FIG. 3, the proxy device 120 may send a service discovery message (e.g., the frame 230) to the devices 210, 310, 320, 330 in the NAN 108 on behalf of the client device 110.

According to one implementation, the proxy device sends the service discovery message in response to receiving a query, a subscription message, or both. The subscription message may include information related to a particular service to be advertised by the proxy device.

According to one implementation, the method 510 includes generating, at the proxy device, a frame including discovery proxy capability information. The discovery proxy capability information indicates proxy capabilities of the proxy device. The method 510 may also include sending the frame form the proxy device to at least one device of the one or more other devices. The frame may be sent during a discovery window of the network, during an advertised availability time outside of the discovery window, or during a negotiated availability time outside of the discovery window.

The discovery proxy capability information indicates one or more proxy capability attributes of the proxy device. According to one implementation, the one or more proxy capability attributes indicate how frequently the proxy device is in an active state to proxy advertise the service for a publisher device, a power attribute of the proxy device, how many services that the proxy device is able to proxy advertise, whether the proxy device is accepting new registrations, a duration that the proxy device is available to proxy advertise a particular service, a duration that the proxy device advertises services before requesting reregistration with the proxy device, or a combination thereof. According to one implementation, the one or more proxy capability attributes indicate an amount of service information to be advertised for each service of the publisher device, that a short service information field for each service will be proxy advertised, whether the proxy device proxy advertises services in a beacon frame, or a combination thereof. According to one implementation, the one or more proxy capability attributes indicate a time that the proxy device is available for registration, whether the proxy device supports unsolicited service discovery, whether the proxy device supports solicited service discovery, whether the proxy device supports publishing, whether the proxy device supports subscriptions, publisher device compatibility criteria, subscriber device compatibility criteria, or a combination thereof.

The method 510 may also include sending a query from the proxy device to the client device. The method 510 may include discontinuing proxy advertisement of the service at the proxy device if the proxy device fails to receive a response to the query within a particular time period (e.g., 512 milliseconds (ms), 1024 ms, etc.). The method 510 may also include continuing proxy advertisement of the service at the proxy device if the proxy device receives the response to the query within the particular time period. According to one implementation, the query indicates to the client device that the proxy device is advertising the service.

The method 510 also includes performing a registration operation at the proxy device to register a subscription request of a subscriber device. Registering the subscription request enables the proxy device to discover services associated with the subscription request on behalf of the subscriber device. The registration operation may be performed during a discovery window of the network, during an advertised availability time outside of the discovery window, or during a negotiated availability time outside of the discovery window. The method 510 may also include sending subscription messages from the proxy device to the one or more other devices in the network to discover services associated with the subscription request. The method 510 may also include detecting, at the proxy device, services associated with the subscription request without transmitting subscription messages to the one or more other devices in the network.

According to one implementation of the method 510, the client device publishes the service in response to detecting a subscription message. According to another implementation of the method 510, the client device publishes the service according to an unsolicited protocol.

According to one implementation of the method 510, the client device 110 is the subscriber of the service. The transceiver 126 is further operable to send information associated with the publisher of the service to the client device 110. According to another implementation of the method 510, the client device 110 is the publisher of the service. The transceiver 126 is further operable to send information associated with the subscriber of the service to the client device 110.

According to one implementation of the method 510, the processor 124 may initiate a registration operation at the proxy device 120 to register the service with the proxy device 120, wherein registering the service enables the proxy device 120 to proxy advertise the service to the one or more devices in the network. The transceiver 126 is further operable to receive service information at the proxy device 120 from the client device 110 during the registration operation. According to one implementation, the service information includes a media access control (MAC) address of the client device 110, a service identifier of the service, a discovery window wake-up schedule of the client device 110, information associated with a data link of the client device 110, ranging information of the client device 110, post discovery capability information of the client device 110, proxy advertisement timeline information, information associated with a service discovery mode, or a combination thereof. The registration operation may be performed during a discovery window of the network, during an advertised availability time outside of the discovery window, or during a negotiated availability time outside of the discovery window.

According to one implementation of the method 510, the processor 124 may initiate transmission of a query from the proxy device 120 to the client device 110, the query including updates to negotiated parameters between the client device 110 and the proxy device 120. The transceiver 126 may send the query to the client device 110. The client device 110 discontinues use of the proxy device 120 if the client device 110 rejects the updates. The client device 110 acknowledges the updates if the client device 110 accepts the updates.

According to one implementation, the method 510 includes proxy advertising the service based on a mode of advertisement of the client device 110. Proxy advertising the service comprises sending service discovery broadcast messages if the mode of advertisement is an active mode of advertisement. The method 510 may also include aggregating multiple proxy requests into a service discovery frame, where each proxy request is associated with a different service. According to one implementation, the service discovery frame includes multiple service descriptor attributes, where each service descriptor attribute is associated with a different service. According to one implementation, the method 510 includes applying a filter (e.g., a bloom filter) to the service discovery frame.

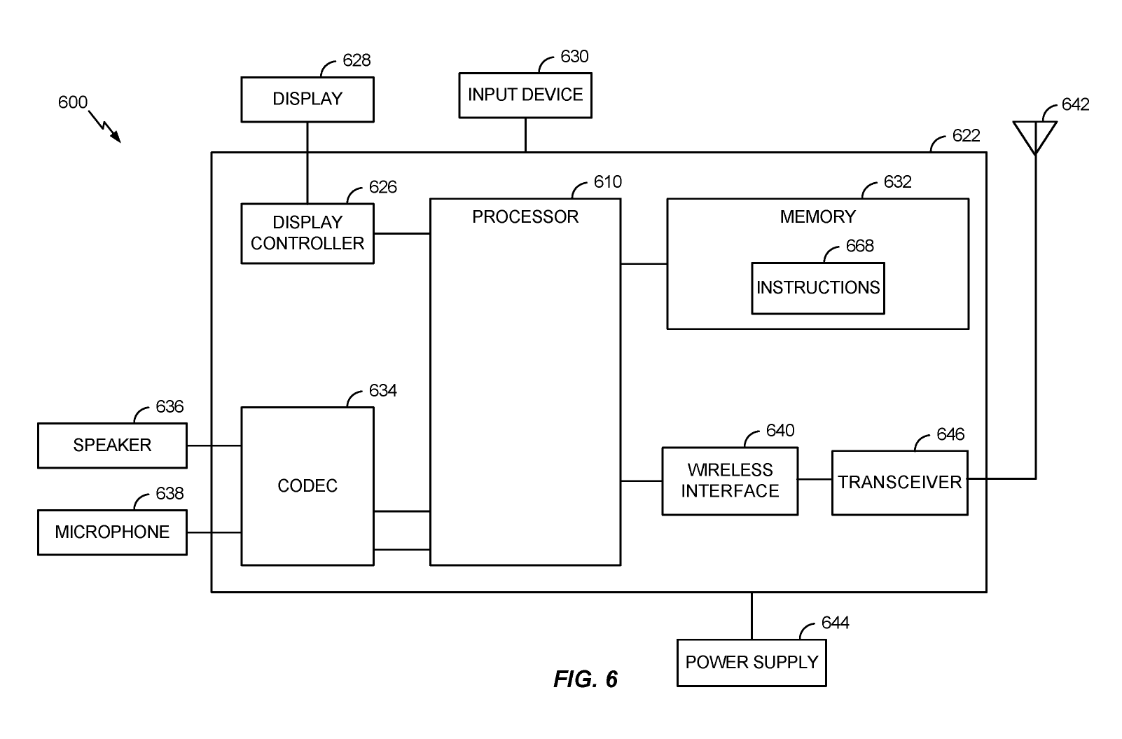

Referring to FIG. 6, a device is depicted and generally designated 600. The device 600 may correspond to any one of the devices 110, 120, 210, 310, 320, 330 of FIGS. 1-3. The device 600 includes a processor 610, such as a digital signal processor or central processing unit, coupled to a memory 632.

The processor 610 may correspond to the processor 114 of FIG. 1, the processor 124 of FIG. 1, the processor 214 of FIG. 2, or a processor within the devices 310, 320, 330 of FIG. 3. The processor 610 may be configured to execute software, such as a program of one or more instructions 668, stored in the memory 632. Additionally or alternatively, the processor 610 may be configured to execute one or more instructions stored in a memory of a wireless interface 640, such as an IEEE 802.11 interface configured to operate in accordance with an IEEE 802.11 standard. In some implementations, the processor 610 may be configured to operate in accordance with the method 400 of FIG. 4, the method 500 of FIG. 5A, or the method 510 of FIG. 5B. For example, if the device 600 is a proxy device, the processor 610 may generate a frame including discovery proxy capability information. Alternatively, if the device 600 is a client device, the processor 610 may select a proxy device to proxy advertise a service. If the device 600 is a subscriber device, the processor 610 may initiate subscription to the service in response to receiving a proxy advertisement from a proxy device. According to one implementation, the processor 610 may be configured to operate in accordance with each method 400, 500, 510 of FIGS. 4-5B. For example, the device 600 may be a client device of a first service, a proxy device for a second service, and a subscriber device of a third service.

The wireless interface 640 may be coupled to the processor 610 and to an antenna 642. For example, the wireless interface 640 may be coupled to the antenna 642 via a transceiver 646. The transceiver 646 may correspond to the transceiver 116 of FIG. 1, the transceiver 126 of FIG. 1, the transceiver 216 of FIG. 2, or a transceiver within the devices 310, 320, 330 of FIG. 3. In some implementations, the transceiver 646 may be configured to operate in accordance with the method 400 of FIG. 4, the method 500 of FIG. 5A, or the method 510 of FIG. 5B. For example, the transceiver 646 may transmit a frame during a discovery window of a NAN according to the method 400 of FIG. 4. The transceiver 646 may also send registration data to a proxy device according to the method 500 of FIG. 5A. The transceiver may also receive a proxy advertisement of a service from a proxy device according to the method 510 of FIG. 5B.

A coder/decoder (CODEC) 634 can also be coupled to the processor 610. A speaker 636 and a microphone 638 can be coupled to the CODEC 634. A display controller 626 can be coupled to the processor 610 and to a display device 628. In a particular implementation, the processor 610, the display controller 626, the memory 632, the CODEC 634, and the wireless interface 640 are included in a system-in-package or system-on-chip device 622. In a particular implementation, an input device 630 and a power supply 644 are coupled to the system-on-chip device 622. Moreover, in a particular implementation, as illustrated in FIG. 6, the display device 628, the input device 630, the speaker 636, the microphone 638, the antenna 642, and the power supply 644 are external to the system-on-chip device 622. However, each of the display device 628, the input device 630, the speaker 636, the microphone 638, the antenna 642, and the power supply 644 can be coupled to one or more components of the system-on-chip device 622, such as one or more interfaces or controllers.

In conjunction with the described techniques, a first apparatus includes means for generating, at a proxy device of a network, a frame including discovery proxy capability information. The discovery proxy capability information indicates proxy capabilities of the proxy device. For example, the means for generating the frame includes the processor 124 of FIGS. 1-2, the processor 610 programmed to execute the instructions 668 of FIG. 6, one or more other devices, circuits, modules, or any combination thereof.

The first apparatus may also include means for sending the frame to one or more devices in the network. For example, the means for sending the frame may include the transceiver 126 of FIGS. 1-2, the transceiver 646 of FIG. 6, one or more other devices, circuits, modules, or any combination thereof. The proxy device may include the means for generating the frame and the means for transmitting the frame.

In conjunction with the described techniques, a second apparatus includes means for selecting, a client device, a proxy device to proxy advertise a service of the client device to one or more other devices in a network. For example, the means for selecting the proxy device may include the processor 114 of FIG. 1, the processor 610 programmed to execute the instructions 668 of FIG. 6, one or more other devices, circuits, modules, or any combination thereof.

The second apparatus may also include means for sending registration data from the client device to the proxy device. For example, the means for sending the registration data may include the transceiver 116 of FIG. 1, the transceiver 646 of FIG. 6, one or more other devices, circuits, modules, or any combination thereof.

In conjunction with the described techniques, a third apparatus includes means for receiving, at a client device, a frame from the proxy device. The frame includes discovery proxy capability information that indicates proxy capabilities of the proxy device. For example, the means for receiving the frame may include the transceiver 216 of FIG. 2, the transceiver 646 of FIG. 6, one or more other devices, circuits, modules, or any combination thereof.

The third apparatus may also include means for determining whether to use the proxy device for proxy advertisement based on the discovery proxy capability information. For example, the means for determining may include the processor 214 of FIG. 2, the transceiver 216 of FIG. 2, the processor 610 programmed to execute the instructions 668 of FIG. 6, the transceiver 646 of FIG. 6, one or more other devices, circuits, modules, or any combination thereof.

In conjunction with the described techniques, a fourth apparatus includes means for detecting, at a proxy device of a network, a client device having access to the network. For example, the means for detecting may include the processor 124 of FIG. 1, the processor 610 programmed to execute the instructions 668 of FIG. 6, one or more other devices, circuits, modules, or any combination thereof.

The fourth apparatus also include means for sending a service discovery message from the proxy device to one or more other devices in the network. The service discovery message is associated with a service and is sent on behalf of the client device. The client device is a publisher of the service or a subscriber of the service. For example, the means for sending may include the transceiver 126 of FIG. 1, the transceiver 646 of FIG. 6, one or more other devices, circuits, modules, or any combination thereof.

Those of skill in the art would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (or non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for sending one or more service discovery messages, the method comprising:
detecting, at a proxy device of a network, a client device having access to the network; and
sending a service discovery message from the proxy device to one or more other devices in the network, the service discovery message associated with a service and sent on behalf of the client device, wherein the client device is a publisher of the service or a subscriber of the service.

2. The method of claim 1, wherein the network includes a Neighbor Aware Network (NAN).

3. The method of claim 1, wherein the proxy devices sends the service discovery message in response to receiving a query, a subscription message, or both.

4. The method of claim 3, wherein the subscription message includes information related to a particular service to be advertised by the proxy device.

5. The method of claim 1, further comprising:
generating, at the proxy device, a frame including discovery proxy capability information, the discovery proxy capability information indicating proxy capabilities of the proxy device; and
sending the frame from the proxy device to at least one device of the one or more other devices.

6. The method of claim 5, wherein the frame is sent during a discovery window of the network, during an advertised availability time outside of the discovery window, or during a negotiated availability time outside of the discovery window.

7. The method of claim 5, wherein the discovery proxy capability information indicates one or more proxy capability attributes of the proxy device.

8. The method of claim 7, wherein the one or more proxy capability attributes indicate how frequently the proxy device is in an active state to proxy advertise the service for a publisher device, a power attribute of the proxy device, how many services that the proxy device is able to proxy advertise, whether the proxy device is accepting new registrations, a duration that proxy device is available to proxy advertise a particular service, a duration that the proxy device advertises services before requesting reregistration with the proxy device, an amount of service information to be advertised for each service of the publisher device, that a short service information field for each service will be proxy advertised, whether the proxy device proxy advertises services in a beacon frame, a time that the proxy device is available for registration, whether the proxy device supports unsolicited service discovery, whether the proxy device supports solicited service discovery, whether the proxy device supports publishing, whether the proxy device supports subscriptions, publisher device compatibility criteria, subscriber device compatibility criteria, or a combination thereof.

9. The method of claim 1, further comprising:
sending a query from the proxy device to the client device;
discontinuing proxy advertisement of the service at the proxy device if the proxy device fails to receive a response to the query within a particular time period; and
continuing proxy advertisement of the service at the proxy device if the proxy device receives the response to the query within the particular time period.

10. The method of claim 9, wherein the query indicates to the client device that the proxy device is advertising the service.

11. The method of claim 1, further comprising performing a registration operation at the proxy device to register a subscription request of a subscriber device, wherein registering the subscription request enables the proxy device to discover services associated with the subscription request on behalf of the subscriber device.

12. The method of claim 11, wherein the registration operation is performed during a discovery window of the network, during an advertised availability time outside of the discovery window, or during a negotiated availability time outside of the discovery window.

13. The method of claim 11, further comprising sending subscription messages from the proxy device to the one or more other devices in the network to discover services associated with the subscription request.

14. The method of claim 11, further comprising detecting, at the proxy device, services associated with the subscription request without transmitting subscription messages to the one or more other devices in the network.

15. An apparatus for sending one or more service discovery messages, the apparatus comprising:
a processor;
a memory storing instructions executable to cause the processor to detect, at a proxy device of a network, a client device having access to the network; and
a transceiver operable to send a service discovery message from the proxy device to one or more other devices in the network, the service discovery message associated with a service and sent on behalf of the client device, wherein the client device is a publisher of the service or a subscriber of the service.

16. The apparatus of claim 15, wherein the client device publishes the service in response to detecting a subscription message.

17. The apparatus of claim 15, wherein the client device publishes the service according to an unsolicited protocol.

18. The apparatus of claim 15, wherein the client device is the subscriber of the service, and wherein the transceiver is further operable to send information associated with the publisher of the service to the client device.

19. The apparatus of claim 15, wherein the client device is the publisher of the service, and wherein the transceiver is further operable to send information associated with the subscriber of the service to the client device.

20. The apparatus of claim 15, wherein the instructions are further executable to cause the processor to initiate a registration operation at the proxy device to register the service with the proxy device, wherein registering the service enable the proxy device to proxy advertise the service to the one or more devices in the network.

21. The apparatus of claim 20, wherein the transceiver is further operable to receive service information at the proxy device from the client device during the registration operation.

22. The apparatus of claim 21, wherein the service information includes a media access control (MAC) address of the client device, a service identifier of the service, a discovery window wake-up schedule of the client device, information associated with a data link of the client device, ranging information of the client device, post discovery capability information of the client device, proxy advertisement timeline information, information associated with a service discovery mode, or a combination thereof.

23. The apparatus of claim 20, wherein the registration operation is performed during a discovery window of the network, during an advertised availability time outside of the discovery window, or during a negotiated availability time outside of the discovery window.

24. A non-transitory computer-readable medium comprising instructions for sending one or more service discovery messages, the instructions, when executed by a processor of a proxy device, cause the processor to perform operations including:
detecting a client device having access to a network associated with the proxy device; and
initiating transmission of a service discovery message from the proxy device to one or more other devices in the network, the service discovery message associated with a service and sent on behalf of the client device, wherein the client device is a publisher of the service or a subscriber of the service.

25. The non-transitory computer-readable medium of claim 24, wherein the operations further include initiating transmission of a query from the proxy device to the client device, the query including updates to negotiated parameters between the client device and the proxy device.

26. The non-transitory computer-readable medium of claim 25, wherein the client device discontinues use of the proxy device if the client device rejects the updates, and wherein the client device acknowledges the updates if the client device accepts the updates.

27. The non-transitory computer-readable medium of claim 24, wherein the operations further include proxy advertising the service based on a mode of advertisement of the client device, wherein proxy advertising the service comprises sending service discovery broadcast messages if the mode of advertisement is an active mode of advertisement.

28. The non-transitory computer-readable medium of claim 24, wherein the operations further include passively detecting the service to proxy advertise to the client device if the client device operates according to a passive mode of advertisement.

29. The non-transitory computer-readable medium of claim 24, wherein the operations further include aggregating multiple proxy requests into a service discovery frame, each proxy request associated with a different service.

30. The non-transitory computer-readable medium of claim 29, wherein the service discovery frame includes multiple service descriptor attributes, and wherein each service descriptor attribute is associated with a different service.

31. The non-transitory computer-readable medium of claim 29, wherein the operations further include applying a filter to the service discovery frame.

32. The non-transitory computer-readable medium of claim 31, wherein the filter includes a bloom filter.

33. An apparatus for sending one or more service discovery messages, the apparatus comprising:
means for detecting, at a proxy device of a network, a client device having access to the network; and
means for sending a service discovery message from the proxy device to one or more other devices in the network, the service discovery message associated with a service and sent on behalf of the client device, wherein the client device is a publisher of the service or a subscriber of the service.

34. The apparatus of claim 33, wherein the proxy device is included in a backhaul network.
